(19) United States
(12) Patent Application Publication
(10) Pub. No.: US 2007/0174414 A1
(43) Pub. Date: Jul. 26, 2007

(54) Network terminal operated by downloadable operating system and operating method thereof

(75) Inventors: Young-Gil Song, Seoul (KR); Klaus A. Maier, Pleinfeld (DE)

Correspondence Address: BIRCH STEWART KOLASCH & BIRCH, PO BOX 747, FALLS CHURCH, VA, 22040-0747, US

(73) Assignee: NCOMPUTING CO., LTD., KOREA REPUBLIC OF (KR)

(21) Appl. No.: 10/590,220

(22) PCT Filed: Feb. 18, 2005
(86) PCT No.: PCT/KR05/00455

§ 371 Date: Aug. 22, 2006

(30) Foreign Application Priority Data
Feb. 23, 2004 (KR) 10-2004-0012030

(51) Int. Cl. G06F 15/16

(52) U.S. Cl. 709/217

(57) ABSTRACT

A network terminal operated by a downloadable operating system is provided. In the network terminal, a power supply supplies a power to an element of the network terminal, a nonvolatile storage medium stores a basic input/output system (BIOS) that automatically operates upon the supplying of the power, a controller is initialized by the operation of the BIOS in order to enable a connection between the network terminal and a host computer and to enable a download of a terminal operating system (OS) from the host computer to the network terminal, and a volatile storage medium stores the terminal OS downloaded from the host computer.

### TECHNICAL FIELD

The present invention relates to a network terminal operated by a downloadable operating system and operating method thereof, and more particularly, to a network terminal and operating method thereof, in which the network terminal is operated by an operating system downloaded from a remote host computer, all manipulations of the terminal user are fully executed at the host computer, and the execution results are outputted from the host computer to a monitor or other output device of the network terminal.

### BACKGROUND ART

In recent years, with an increase in use of personal computers (PC), the personal computers have become high-priced and big-sized to satisfy customer's various demands. However, this causes several side effects, especially, increase in total cost of deployment, maintenance cost and high demand of data security. To solve these problems, a thin client/server system is newly introduced and focused.

A thin client denotes a slim, lightweight terminal with minimum system requirements, which have developed to replace the heavyweight, big-sized, and space-consuming personal computer.

In detail, the thin client uses application programs stored in a high performance server PC each time the program is needed. The application programs are executed at the server not at the thin client and then merely output values are displayed on a monitor of the thin client at remote location. Of course, after the execution, output values are stored in a user's folder of the server.

Further, a plurality of users can independently use the application programs of the server at the same time, such that the users feel as if they use their own computers. Today's personal computer horsepower is powerful enough to support multi-users simultaneous computing without requiring expensive traditional mainframe or high-end server computer. Thin client/server computing will be popular in the future in home or office environment when client computer or terminal cost gets cheaper than ordinary PC.

FIG. 1 is a schematic view of a thin client/server system according to the related art.

Referring to FIG. 1, a high-performance server 101 and a plurality of thin clients 130 are connected through network. The server 101 executes its application program when the thin client 130 demands, and compresses the execution result into image data and sends it the thin client 130. Then the thin client 130 displays the received image data on its monitor.

This kind of thin client (terminal) 130 is different from the personal computer in appearance and especially in operating way. That is, as is apparent from the fact that the thin client system is also called a “server based computing”, all necessary application programs are installed in the server 101, and the thin client 130 accesses the server 101 to execute a certain application program and then receives the execution result in the form of image data from the server to display it on its monitor.

FIG. 2 is a flowchart showing a method of transmitting a graphic data from a server to a thin client in a thin client network system according to the related art.

Referring to FIG. 2, in step P10, the thin client 130 is started up by a firmware (BIOS) and an embedded operating system (OS) for its own boot-up procedure to get ready.

In step P20, the thin client 130 accesses the server 101 by using a TCP/IP or IPX protocol. After a simple authentication, the thin client 130 passes to step P30.

In step P30, the thin client 130 transmits a user's command, received through an input device such as a keyboard and a mouse, to the server 101, and then the server 101 runs an application program such as a Window media player or a word processor according to the user's command. That is, the server 101 executes the application program upon the demand of the thin client 130.

In step P40, calculation, saving, or result according to the execution of the application program is converted into graphic data, and the graphic data is transmitted to the thin client 130 through network.

In step P50, the client 130 displays the received graphic data on the monitor.

This access and communication system between the server and the thin client is realized by an independent computing architecture (ICA) from Citrix Systems, Inc., or a remote desktop protocol (RDP) from Microsoft Corporation. In the RDP, a Windows terminal server with a Citrix WinFrame or MetaFrame is used.

Products of the Citrix support various kinds of clients such as DOS, OS/2, Linux, and Java based operating system installed clients to work with its remote server .

In the network system using the thin client 130, each client, unlike the personal computer, is not required to install application programs and peripheral devices, such that the hardware and software size of the client as well as the cost for hardware can be remarkably reduced, thereby providing advantages in a spatial point of view. Also, maintenance cost of the client can be remarkably reduced because the local storage peripheral devices that are the main source of trouble are not used.

In the thin client/server system, however, a Windows 2000 server or higher-level server should be used for the server 101. Also, the thin client terminal 130, as well as the server, should have a separate CPU for the control and processing of its own system.

Further, the thin client 130 requires a separate individual OS for its operation, a high capacity memory and RAM for the OS, a BIOS firmware for storing set parameters of its elements, a plurality of connection means (e.g., a serial port, a parallel port, a USB port, a PCMCIA slot, a speaker/microphone jack), and so on.

As described above, though the thin client terminal of the related art does not require a hard disk (HDD), a floppy disk, and a CD-ROM drive, it still requires a CPU and a local OS to perform and thereby requires additional material cost for them.

Also, since each thin client terminal has its own OS, upgrade or change of the OS must be separately performed on each OS that is installed in the form of firmware or embedded OS, thereby increasing maintenance cost and time.

### DISCLOSURE OF THE INVENTION

Accordingly, the present invention is directed to a network terminal operated by a downloadable operating system (OS) and operating method thereof, which that substantially obviates one or more problems due to limitations and disadvantages of the related art.

An object of the present invention is to provide a network terminal operated by a downloadable operating system and operating method thereof, in which each manipulation of a network terminal user is executed at a remote server computer (hereinafter, referred to as a host computer) connected with the network terminal that is operated by a tiny terminal OS downloaded from the host computer, and the result of the execution at the host computer is outputted on a monitor or the like device of the network terminal, such that the network terminal can be constructed with a System on a Chip (SoC: a programmable logic chip) and low-capacity memories instead of a current common microprocessor or central processing unit (CPU) and high-capacity memories, thereby attaining a multi-access system with a minimum cost.

Additional advantages, objects, and features of the invention will be set forth in part in the description which follows and in part will become apparent to those having ordinary skill in the art upon examination of the following or may be learned from practice of the invention. The objectives and, other advantages of the invention may be realized and attained by the structure particularly pointed out in the written description and claims hereof as well as the appended drawings.

To achieve these objects and other advantages and in accordance with the purpose of the invention, as embodied and broadly described herein, a network terminal operated by a downloadable operating system includes: a power supply for supplying a power to an element of the network terminal; a nonvolatile storage medium for storing a basic input/output system (BIOS) that automatically operates upon the supplying of the power; a controller to be initialized by the operation of the BIOS in order to enable a connection between the network terminal and a host computer and a download of a terminal OS from the host computer to the network terminal; and a volatile storage medium for storing the terminal OS downloaded from the host computer.

In another aspect of the present invention, a method of operating a network terminal with a downloadable operating system includes the steps of: supplying a power to a network terminal; checking the network terminal and initializing a controller of the network terminal by using a BIOS of the network terminal that is automatically executed upon the supplying of the power; connecting the network terminal with a host computer through a network and downloading a terminal OS from the host computer to the network terminal, under control of the initialized controller; storing the downloaded terminal OS in a volatile storage medium; and performing a network terminal user's manipulation at the host computer and transmitting a corresponding result from the host computer to the network terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a thin client/server system according to the related art;

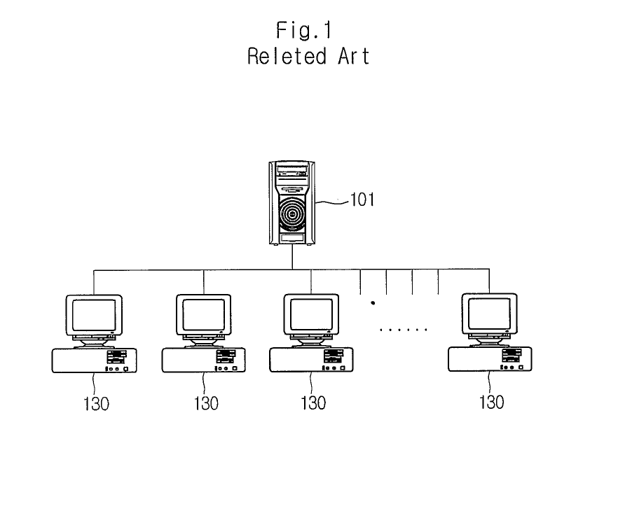

FIG. 2 is a flowchart showing a method of transmitting a graphic data from a server to a thin client in a thin client network system according to the related art;

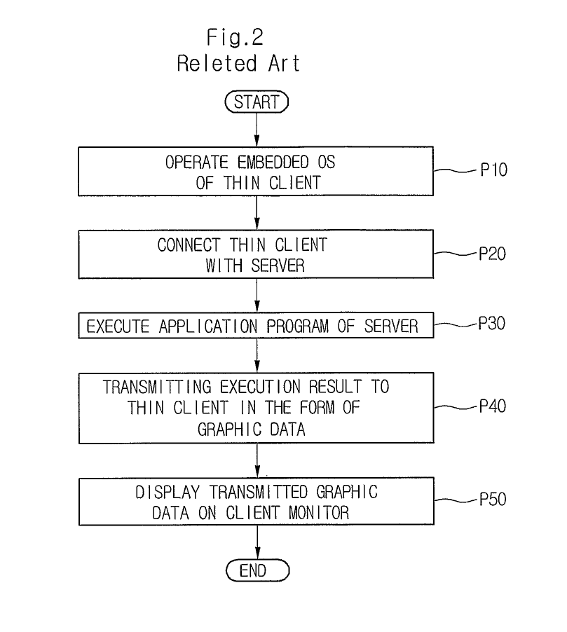

FIGS. 3 is a schematic view of a system with a network terminal operated by a download type operating system according to an embodiment of the present invention;

FIG. 4 is a block diagram showing an inner structure of a host computer depicted in FIG. 3;

FIG. 5 is a block diagram showing an inner structure of a network terminal depicted in FIG. 3; and

FIG. 6 is a flowchart showing an operation of a system with a network terminal operated by a downloadable operating system according to an embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

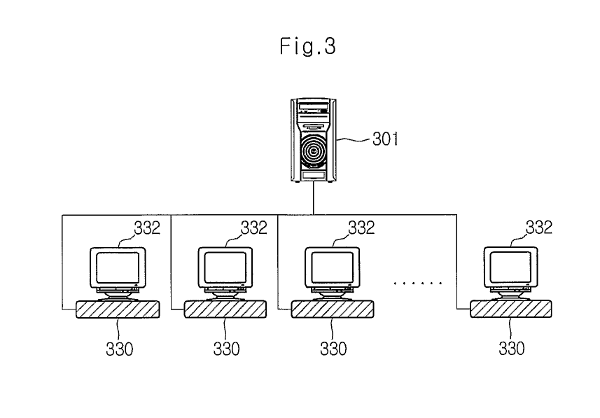

FIGS. 3 is a schematic view of a system with a network terminal operated by a download type operating system according to an embodiment of the present invention.

Referring to FIG. 3, a system includes a host computer 301 allowing multi-access thereto (functioning as a server) and a plurality of network terminals 330 connected to the host computer 301 via network. Users can use application programs of the host computer 301 through the network terminals 330. Substantially, each of the plural network terminals 330 has the same structure and operation. Therefore, the following description will be carried out about one of the network terminals 330 and if necessary the plurality of network terminals 330 will be referred.

In detail, the application program of the host computer 301 is executed upon the demand of the network terminal 330. The execution result is converted into a bitmap image and transmitted from the host computer 301 to the network terminal 330 and then the bitmap image is displayed on a monitor of the network terminal 330. That is, the host computer 301 is provided with all application programs the users intend to use, and the network terminal 330 connected to the host computer 301 is used in a manner such that the network terminal 330, if necessary, accesses the host computer 301 to execute the application program and receives only the execution result (the bitmap image) through the network and displays it on its monitor.

Herein, the network terminal 330 of the present invention is not provided with an embedded OS, such that it downloads a terminal OS from the host computer 301 through the network each time it operates. Terminal does not work as client computer independently until it connects to host computer and download its new operating system to boot up unlike traditional thin-client computer which still run as an independent computer without network connection to host computer.

Therefore, the host computer 301 has the terminal OS for operating each network terminal 330 and provides the terminal OS to each network terminal 330 upon the access of each network terminal 330.

Eventually, according to the present invention, the network terminal 330 downloads the terminal OS from the host computer 301 for its operation, such that the network terminal 330 can use a programmable System on a Chip (SoC) and a low-capacity memory instead of a fixed instruction based CPU and a high-capacity memory, thereby realizing a multi-access computing system with a minimum cost.

That is, the host computer 301 is provided with the terminal OS to supports the multi-access of the network terminals 330, and the terminal OS is downloaded to the network terminal 330 upon the access of the network terminal 330 though the network such a LAN or an Internet. After the download, the network terminal 330 can be operated to access the application programs of the host computer 301.

Further, the network terminal 330 uses a blank state, programmable, System on a Chip (SoC) instead of the CPU as its controller according to an embodiment of the present invention.

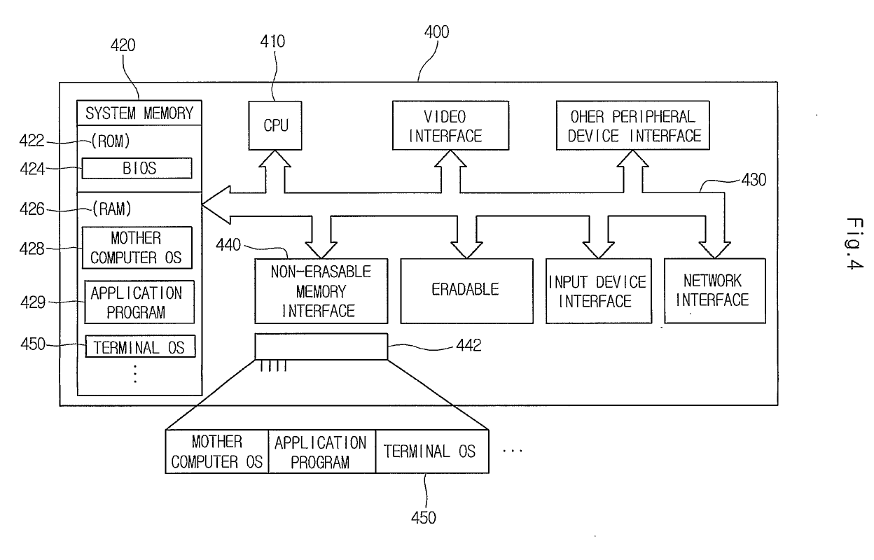

FIG. 4 is a block diagram showing an inner structure of a host computer depicted in FIG. 3. The structure shown in the FIG. 4 is an exemplary one and thus the structure of the host computer is not limited to that.

Referring to FIG. 4, a host computer 400 includes a CPU 410, a system memory 420, and a system bus 430 for connecting various system elements including the system memory 420 with the CPU 4310.

The CPU 410 is a device that controls overall operation of computer system. The CPU 410 controls a sequential operation of receiving data from various input devices, processing the data, and sending the process result to an output device.

Generally, the term “CPU: central processing unit” is used for medium-sized and large-sized computers, and “microprocessor” or, shortly, “processor” is sometimes used for small-sized computers instead of the term CPU. However, their function is substantially the same as described above.

The CPU 410 includes an arithmetic logic unit (ALU) and a control unit. The ALU performs comparison, decision, and calculation operations, and the control unit decodes and executes instructions.

In detail, the ALU includes: an adder for adding numbers; an accumulator, a kind of register, for temporarily storing the result of arithmetic and logic operations; and a register, a kind of temporary storage of CPU. The control unit includes a program counter for controlling an execution order of programs, and an instruction register for temporarily storing a current instruction, and an instruction decoder for decoding the stored instruction to send a control signal to a corresponding device. Therefore, CPU based terminal can perform independently based on instructions programmed regardless network connection to host computer unlike SoC based terminal of the present invention.

The system bus 430 may be one of several types of bus structures that include a memory bus or memory controller, a peripheral device bus, and a local bus using various bus architectures. For example, such bus structure includes an industry standard architecture (ISA) bus, a micro channel architecture (MCA) bus, an enhanced ISA (EISA) bus, a video electronics standard association (VESA) local bus, and a PCI bus (mezzanine bus).

All elements and one element of the host computer 400 that are illustrated in FIG. 4 are connected one another through a standard high-speed computer network including a computer network that spans a wide area. For example, though the system memory 420 and the CPU 410 may be physically separated, they can be combined in a logic computer.

Further, the host computer 400 may include various kinds of computer readable mediums. The computer readable medium may be any kind of medium the host computer 400 can access. That is, the computer readable medium includes volatile, nonvolatile, erasable, and non-erasable mediums.

For example, the computer readable medium includes RAM, ROM, EEPROM, flash memory or other memories, CD-ROM, DVD or other optical disk storages, magnetic cassette, magnetic tape, magnetic disk or other magnetic storage.

A communication medium is associated with a computer readable instruction, a data structure, a program module or a modulated data signal such as a carrier signal or other transmitting mechanism. The communication medium includes a data transmission medium.

The system memory 420 includes computer storage mediums, a ROM 422 (nonvolatile memory) and a RAM 426 (volatile memory). A basic input/output system (BIOS) 424 is usually stored in the ROM 422, the BIOS 424 having a basic routine for a data transmission among the elements of the host computer 400 during a start-up of the host computer 400.

The RAM 426 stores a data and/or program module that are currently used or to be accessed by the CPU 410. For example, a host computer OS 428, an application program 429 and other program modules and program data are stored in the RAM 426 as shown in FIG. 4.

Further, the host computer 400 may includes various interfaces. For example, in FIG. 4 are shown an unremovable/non-volatile storage interface 440, a removable/nonvolatile storage interface, an input device interface, a network interface, a video interface, and other peripheral device interface.

The HDD 442 is connected with the system bus 430 through the unremovable/non-volatile storage interface 440, and the magnetic disk drive or optical disk drive may be connected with the system bus 430 through the removable/nonvolatile storage interface.

The host computer 400 of the present invention includes the host computer OS 428 for its operation and as well a terminal OS 450 for the operation of the network terminal.

The network terminal OS 450 may be stored in the HDD 442 and uploaded in the RAM 426 for an access by the CPU 410. The function of the drive devices and storage mediums exemplarily shown in FIG. 4 is to provide readable data storages to the host computer 400 for storing and reading instructions, data structures, program modules, and other data.

Generally, the user inputs orders and data into a computer by using a mouse or a pointing device such as a tracker ball and a touch pad.

The CPU 410 may access such orders and data through the input device interface connected with the system bus 430, or through other interfaces and bus structures such as a parallel port, a game port, and a universal serial bus (USB). A monitor or other type of display is connected with the system bus 430 through an interface such as the video interface.

As described above, the host computer 400 can be logically combined with at least one remote computer. That is, in this way, the host computer 400 is included and is operated in a network system.

Though the remote computer may be a personal computer, a server, a router, a network personal computer, or a peer device or a common network node, a network terminal is used for the remote computer to share resources such as the application programs according to the present invention.

The logical combination between the host computer and the network terminal includes a LAN and a WAN, or other networks. In case of the LAN circumstance, the host computer 400 is connected to the LAN through the network interface, and in case of the WAN circumstance the host computer 400 is connected to the WAN through a modem or other available device.

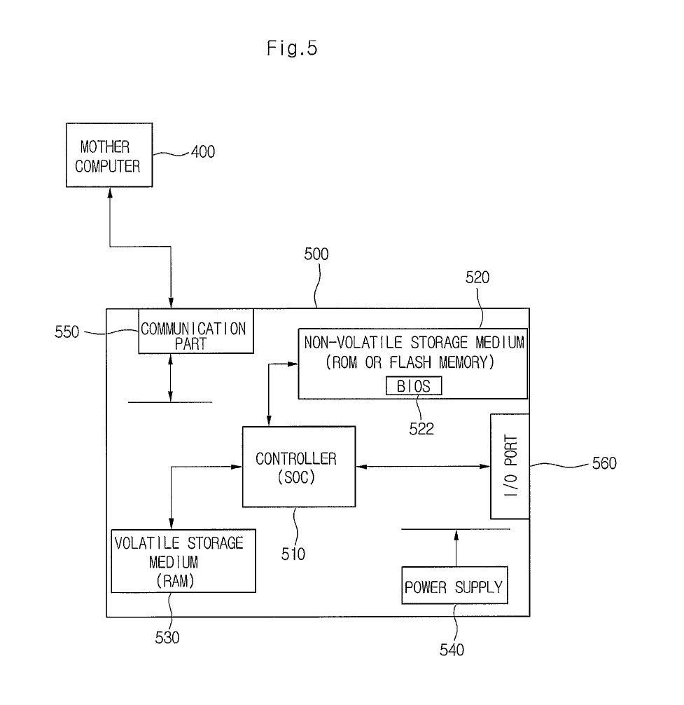

FIG. 5 is a block diagram showing an inner structure of a network terminal depicted in FIG. 3. The illustrated structure is an embodiment of the present invention. The network terminal of the present invention is not limited to the illustrated structure.

Referring to FIG. 5, a network terminal 500 includes: a power supply 540 for supplying a power to an element of the network terminal; a nonvolatile storage medium 522 provided with a basic input/output system (BIOS) that automatically operates when a power is supplied thereto by the power supply; a controller 510 initialized by an operation of the BIOS, the controller controlling a connection between the network terminal and a host computer and controlling a download of a terminal OS from the host computer to the network terminal; and a volatile storage medium 530 storing the downloaded terminal OS.

Further, the network terminal 500 and the host computer 400 may be connected to each other through a LAN or a WAN. For this connection, the network terminal 500 may include a communication part 550 capable of transmitting and receiving data to and from the host computer 400, an encoder (not shown) for encoding the received data, and a plurality of input/output ports 560 for a connection with a plurality of user interfaces.

The plurality of the user interfaces include a monitor, a keyboard, a mouse, a USB port, a PCMCIA slot, speaker and microphone jacks, a touch screen, a remote control, and so on.

The nonvolatile storage medium 520 may be a ROM or a flash memory. The nonvolatile storage medium 520 has a minimum capacity capable of initializing the controller 510. That is, the function of the nonvolatile storage medium 520 is to perform the function of the BIOS upon the power-on of the network terminal 500.

The BIOS 522 is a combination of basic programs for initially controlling the network terminal 500 when powered-on.

The BIOS 522 includes a start-up routine and a service processing routine. When the network terminal 500 is powered-on, the start-up routine is automatically executed to check the state of the network terminal 500 and to initialize the controller 510. Also, the start routine checks whether peripheral devices are connected to the network terminal 500 when initializing the controller 510.

That is, during the initializing step, the BIOS 522 initializes interface modules for the user interfaces (a monitor, a keyboard, and a mouse) and a basic module for the network terminal 500 to be recognized as a network device.

Since the function of the nonvolatile storage medium 520 is to store the BIOS 522 , the capacity of the nonvolatile storage medium 520 is 512 KB or less.

It is apparent that the function of the nonvolatile storage medium 520 can be carried out when the nonvolatile storage medium 520 has a capacity of larger than 512 KB.

The controller 510 initialized by the BIOS 522 enables the network terminal 500 to be recognized as a network device, such that the network terminal 500 can be connected to the host computer 400 through network.

Herein, the host computer 400 and the network terminal 500 have Internet Protocol (IP) addresses, respectively, in order to identify each other.

Therefore, the nonvolatile storage medium 520 is provided with a program enabling the network terminal 500 to have its own IP address.

Further, after initialization, the controller 510 enables the network terminal 500 to download the terminal OS 450 from the host computer 400 as well as it enables the connection between the host computer 400 and the network terminal 500. That is, since the network terminal 500 can download the terminal OS 450 from the host computer 400 when necessary, the network terminal 500 does not requires an OS stored in it.

The terminal OS 450 downloaded by the controller 510 is stored in the volatile storage medium 530.

Therefore, the volatile storage medium 530 is used as a working memory, such that it may be a RAM and of which capacity may be 8 MB or less.

Sometimes, a number of sequential images have to be stored to display moving pictures, or large size image is to be stored for a large screen or high resolution, or the terminal OS must have a plurality of IP addresses. For such cases, a RAM of which capacity is larger than 8 MB can be used for the volatile storage medium 530.

When a system on a chip (SoC) is used for the controller 510, the downloaded terminal OS 450 initializes the controller 510 again.

The re-initializing of the controller 510 allows the network terminal 500 to have an OS for its operation (the terminal OS 450) and the controller 510 that is used to control the overall operation of the network terminal 500 by the terminal OS 450, such that the user can do a work using the network terminal 500. That is, after the re-initializing of the controller 510, the user can access the host computer 400 to execute a necessary application program at the host computer 400, and then the execution result is transmitted from the host computer 400 to the network terminal 500.

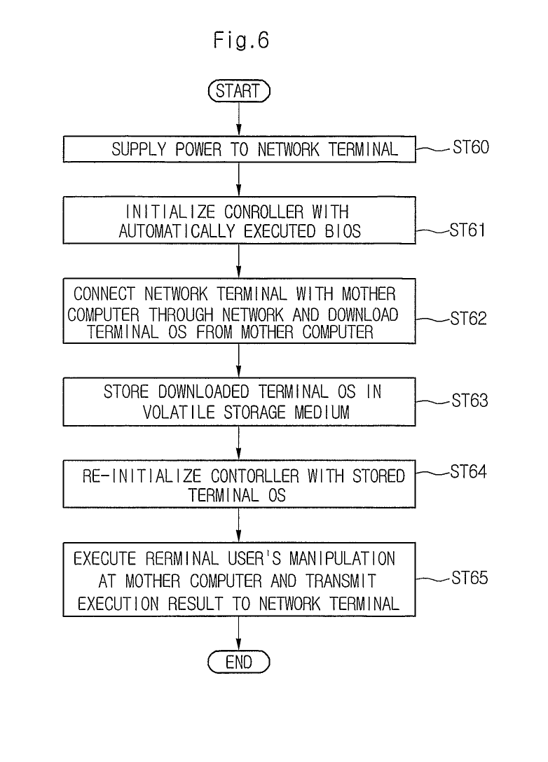

FIG. 6 is a flowchart showing an operation of a system with a network terminal operated by a download type operating system according to an embodiment of the present invention.

Referring to FIGS. 5 and 6, in step ST60, the network terminal 500 is powered-on.

Herein, prior to step ST60, the host computer 400 have connected with network for the connection with the network terminal 500 and normally operated to allow its resource sharing.

That is, the host computer 400 operates its software normally and is connected to the network with its own IP address (on-line state), and also is provided with both its own OS (host computer OS 428) and the terminal OS 450 for allowing the download to the network terminal 500.

In step ST61, the BIOS 522 is automatically executed to check the state of the network terminal 500 and initialize the controller 510.

That is, the BIOS 522 provided in the nonvolatile memory 520 (a ROM or a flash memory) is automatically executed upon the power-on of the network terminal 500 in order to check the state of the network terminal 500 and initialize the controller 510. Also, during the initializing the controller 510, the BIOS 522 searches peripheral devices that are connected to the network terminal 500.

In step ST62, the network terminal 500 and the host computer 400 are connected each other through the network, and the terminal OS 450 stored in the host computer 400 is downloaded to the network terminal 500.

That is, after the controller 510 is initialized, the interface modules for the use interfaces (a monitor, a keyboard, a mouse, etc.) connected to the network terminal 500 are activated, and also the basic network module of the network terminal 500 is activated, such that the network terminal 500 can be recognized as a network device and thereby can be connected to the network terminal 500 through the network.

Herein, the host computer 400 and the network terminal 500 have their own IP addresses to identify each other.

Therefore, the nonvolatile storage medium 520 of the network terminal 500 is provided with a program enabling the network terminal 500 to have its own IP address.

Further, the controller 510 when initialized enables the network terminal 500 to be connected with the host computer 400 on the network, and also enables the network terminal 500 to download the terminal OS 450 from the host computer 400. That is, the network terminal 500 does not store an OS therein; the network terminal 500 downloads the terminal OS 450 from the host computer 400 and executes the terminal OS 450 each time it is necessary.

In step ST63, the downloaded terminal OS 450 is stored in the volatile storage medium 530.

Herein, the volatile storage medium 530 is used as a working memory. Preferably, a RAM can be used for the volatile storage medium 530 and the capacity of the RAM can be 8 MB or less.

If a SoC is used for the controller 510, step ST64 is required. In step ST64, the controller 510 (SoC) is initialized again by the terminal OS 450 stored in the volatile storage medium 530.

The network terminal 500 is not provided with a CPU, a basic element of a normal computer. That is, the SoC re-initialized by the downloaded terminal OS 450 is used for controlling and adjusting the operations (calculation, control, etc.) of the network terminal 500, such that the multi-access computing can be realized with a minimum cost.

With the initializing to the 510, the network terminal 500 comes to have both its operating system (the terminal OS 450) and a controller controlling its overall operation according to the execution of the terminal OS 450, such that the user can carry out his/her work through the network terminal 500 (step ST 65). In detail, though the user manipulates the network terminal 500 to do his/her works, all works of the user are executed by the host computer 400 connected with the network terminal 500 and the user merely receives the execution results through the network terminal 500.

That is, the execution results of the host computer 400 is transmitted to the network terminal 500 in the form of bitmap images, such that the user can see the execution results on a monitor of the network terminal 500.

Herein, the bitmap images may be 8-bit or 16-bit bitmap images, and the image size and resolution of the images can be changed according to the demand of the user. Also, there may be a simple certification step before the transmission of the bitmap images.

Substantially, the user uses application programs of the host computer 400 through the network terminal 500 connected with the host computer 400 on the network.

Therefore, the host computer 400 executes the application program upon the demand of the network terminal 500, and the execution (calculating, saving, etc.) results are converted into the bitmap images and then the bitmap images are transmitted to the network terminal 500 through the network, such that the user can see the results on the monitor of the network terminal 500.

Above-mentioned embodiments of the present invention are exemplary ones for describing the network terminal operated by the downloadable operating system and method thereof. Thus, it will be apparent to those skilled in the art that various modifications and variations can be made in the present invention. Thus, it is intended that the present invention covers the modifications and variations of this invention provided they come within the scope of the appended claims and their equivalents.

For example, in case the network terminal is equipped with a monitor (e.g., an LCD monitor), the remote host computer can automatically update screen memory data of the monitor of the network terminal one-directionally.

### INDUSTRIAL APPLICABILITY

The network terminal using the application programs of the host computer is operated by the terminal OS downloaded from the host computer, such that the multi-access computing can be attained with a minimum cost and malfunction. Also, since all data and application programs are stored in the host computer, reliable data security and virus protection are accomplish.

Further, the network terminal connected with the multi-access host computer is operated by downloading the terminal OS from the host computer instead of storing the OS therein, such that the network terminal can have a simple structure and can be fabricated with a minimum cost. Also, when it is required to update and change the terminal OS, the network terminal can download updated or changed terminal OS each time it is initialized for an operation, such that the software updating and changing for each network terminal can be carried out simultaneously and instantly.

Furthermore, all application programs and data can be managed by handing only the host computer because they are stored and executed only at the host computer, thereby reducing total cost of owner ship (TCO) and total deployment cost (TDC). For example, adding or updating the network terminal can be carried out with a low cost.

1. A network terminal operated by a downloadable operating system, comprising:
a power supply for supplying a power to an element of the network terminal;
a nonvolatile storage medium for storing a basic input/output system (BIOS) that automatically operates upon the supplying of the power;
a controller to be initialized by the operation of the BIOS in order to enable a connection between the network terminal and a host computer and a download of a terminal operating system (OS) from the host computer to the network terminal; and
a volatile storage medium for storing the terminal OS downloaded from the host computer.

2. The network terminal according to claim 1, further comprising:
a communication part to be connected with the host computer, for transmitting/receiving a data to/from the host computer;
an encoder for encoding the received data; and
at least one input/output port to which at least one user interface is connected.

3. The network terminal according to claim 1, wherein the nonvolatile storage medium is a ROM or a flash memory and the capacity of the nonvolatile storage medium is 512 KB or less for storing the BIOS.

4. The network terminal according to claim 1, wherein the controller is implemented with a programmable SoC (system on a chip) instead of a CPU (central processing unit).

5. The network terminal according to claim 4, wherein the controller implemented with the SoC is re-initialized by the terminal OS stored in the volatile storage medium.

6. The network terminal according to claim 1, wherein the volatile storage medium is used as a working memory and is implemented with an 8-MB RAM or less.

7. The network terminal according to claim 1, wherein each of the network terminal and the host computer is assigned a unique IP address to identify each other, for the connection therebetween.

8. The network terminal according to claim 1, wherein the nonvolatile storage medium stores a program enabling the network terminal to have a unique IP address.

9. The network terminal according to claim 2, wherein the at least one user interface includes a monitor, a keyboard, a mouse, a speaker, a microphone, a touch screen, a remote control, or other interfaces using a USB port, a serial port or a memory slot.

10. A method of operating a network terminal with a downloadable operating system, comprising the steps of:
supplying a power to a network terminal;
checking the network terminal and initializing a controller of the network terminal by using a BIOS of the network terminal that is automatically executed upon the supplying of the power;
connecting the network terminal with a host computer through a network and downloading a terminal OS from the host computer to the network terminal, under control of the initialized controller;
storing the downloaded terminal OS in a volatile storage medium; and
performing a network terminal user's manipulation at the host computer and transmitting a corresponding result from the host computer to the network terminal.

11. The method according to claim 10, further comprising the step of re-initializing the controller with the terminal OS stored in the volatile storage medium prior to the step of performing a network terminal user's manipulation at the host computer.

12. The method according to claim 11, wherein the controller is implemented with a programmable SoC instead of a CPU.

13. The method according to claim 10, further comprising the step of running the host computer and connecting the host computer on the network prior to the step of supplying a power.

14. The method according to claim 13, wherein the host computer is provided with the terminal OS for an operation of the terminal network as well as an OS for its operation.

15. The method according to claim 10, wherein each of the network terminal and the host computer is assigned a unique IP address to identify each other, for the connection therebetween.

16. The method according to claim 10, wherein the step of performing the user's manipulation includes the steps of:
transmitting a screen background of the host computer in the form of a bitmap image to the network terminal and displaying the transmitted screen background on a monitor of the network terminal; and
executing an application program of the host computer according to the network terminal user's manipulation, transmitting a result of the execution in the form of a bitmap image to the network terminal, and displaying the transmitted bitmap image on the monitor of the network terminal.

17. The method according to claim 16, wherein each of the bitmap images is a 8 bit format or 16 bit format bitmap image and a simple authentication procedure is optionally employed at either step of transmitting the bitmap image.

18. The method according to claim 16, wherein display area and colors of the monitor are adjustable upon a user's demand.
